(19) United States
(12) Patent Application Publication
(10) Pub. No.: US 2024/0363022 A1
(43) Pub. Date: Oct. 31, 2024

(54) REFRESHABLE BRAILLE DISPLAY SYSTEM

(71) Applicants: PRASOBH K P, Thrissur (IN); PRANAV K P, Thrissur (IN)

(72) Inventors: PRASOBH K P, Thrissur (IN); PRANAV K P, Thrissur (IN)

(21) Appl. No.: 18/508,517

(22) PCT Filed: May 16, 2022
(86) PCT No.: PCT/IB2022/054538

§ 371 Date: Nov. 14, 2023

(30) Foreign Application Priority Data
May 14, 2021 (IN) 202141021853

(51) Int. Cl. G09B 21/00

(52) U.S. Cl. CPC G09B 21/004

(57) ABSTRACT

A refreshable Braille display system (100) includes a plurality of Braille cells (101), an interface (103), and a microcontroller unit (104). Each of the braille cells (101) includes an array of openings such that each opening (101a) houses a Braille dot element (105). A motor (102) is positioned within each opening (101a) to raise or lower the Braille dot element. The microcontroller unit (104) is configured to determine an input received from the interface (103) and selectively control the motor (102) to cause a rotary motion of the selected Braille dot element (105) based on the determined input.

### TECHNICAL FIELD

The present disclosure generally relates to display systems for the blind. More particularly, the present disclosure relates to a refreshable Braille display system which may be used as a standalone device or as an accessory with a computing device.

### BACKGROUND

With increased penetration of the internet into the daily lives of people across the world, transfer of information and content delivery using handheld devices and computing devices, for example, laptops, desktops, etc., have become the norm. This transition towards the acceptance of all things digital has led to a surge of innovation with respect to display systems. However, existing improved display systems designed for the visually impaired are as yet expensive. For example, conventional braille display systems use a wide variety of mechanisms ranging from solenoids, piezoelectric mechanisms, to thin membrane and vacuum pressure mechanisms, which are bulky requiring additional support. Furthermore, these existing devices require the use of both hands of a user while typing. An improved braille display system, which is particularly convenient and easy to use without being prohibitively expensive, is therefore desired.

Accordingly, there is a long felt but unresolved need for a refreshable Braille display system, which is particularly convenient and easy to use without being prohibitively expensive.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The present disclosure addresses the above-mentioned need for a refreshable Braille display system, which is particularly convenient and easy to use without being prohibitively expensive.

The refreshable Braille display system, disclosed herein, includes a plurality of braille cells, an interface, and a microcontroller unit. Each of the braille cells include an array of openings such that each opening represents a Braille dot. At least one motor is positioned within each opening of the array of openings. The interface is configured to receive an input. The microcontroller unit is configured to determine the received input and actuate one or more of the at least one motor based on the determined input.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a refreshable Braille display system; and

FIG. 2 exemplarily illustrates a schematic diagram of the refreshable Braille display system.

FIG. 3A exemplarily illustrates a Braille dot element in a lowered configuration within an opening.

FIG. 3B exemplarily illustrates a Braille dot element in a raised configuration within an opening.

### DETAILED DESCRIPTION OF THE EMBODIMENTS OF THE INVENTION

The following reference numbers are used throughout the description to refer to elements in the figures:
100—Refreshable Braille display system
101—Braille cells
101a—Openings
102—Motor
103—Interface
104—Microcontroller unit

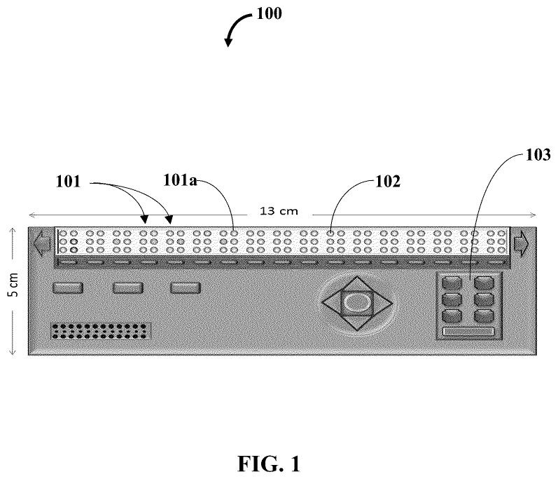

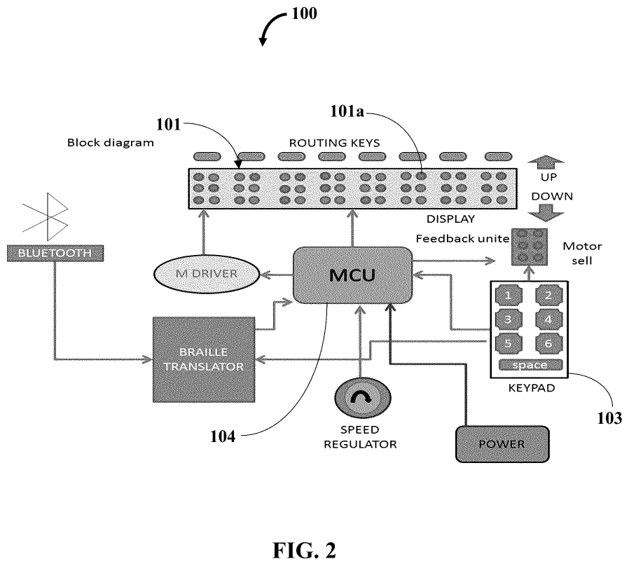

FIG. 1 exemplarily illustrates a refreshable Braille display system 100. FIG. 2 exemplarily illustrates schematic diagram of the refreshable Braille display system 100. The refreshable Braille display system 100 includes a plurality of braille cells 101, an interface 103, and a microcontroller unit 104. Each of the braille cells 101 include an array of openings such that each opening 101a represents a Braille dot. In an embodiment, the refreshable Braille display system 100 includes 14 braille cells 101. Each braille cell 101 may include an array of 6 or 8 dots or openings 101a. At least one motor 102 is positioned within each opening 101a of the array of openings 101a. The motors 102 may be rotatably mounted within the openings 101a of the braille cell 101 such that a portion of the small rotating motors 102 are exposed to be touched by a finger of a user. Visually impaired people can therefore easily differentiate the status of the motor shaft whether the motor rotates or not by touching the motors 102. The interface 103 is configured to receive an input. In an embodiment, the interface 103 is a keypad having keys, for example, nine keys for input data, two keys for jump data to next and previews line, five set of keys for navigation, three special function keys, fourteen routing keys for selecting corresponding alphabets, etc. According to other embodiments of the present disclosure, the interface 103 may be a wireless interface, a wired interface, a touch sensitive interface, a haptic interface, and the like. Each braille dot is represented by rotating motor shaft. In an embodiment, the refreshable Braille display system 100 may be handheld and part of a portable device which can operate in a rechargeable battery. The microcontroller unit 104 is configured to determine the received input and actuate one or more of the at least one motor 102 based on the determined input.

In an embodiment, the refreshable Braille display system 100 has a specially designed keypad 103 having 8 dot keys and a confirmation key. Only after pressing the confirmation key, the refreshable Braille display system 100 reads the data from dot keys. Therefore, simultaneous pressing of dot keys is not needed. In an embodiment according to the present disclosure, the confirmation key is displaced into both sides of the refreshable Braille display system 100 to increase ease of use and convenience for the user. As such, a user can type braille even by using single finger and get the feedback from the keypad as the keypad has a single cell of motors included on the keypad.

During operation, the refreshable Braille display system 100 converts digital data into rotary movement of the motors 102 positioned within the openings 101a. The digital data may be received via the keypad or via a communications network such as a Bluetooth network, a Wi-Fi network, etc. The rotary movement of the motors 102, generates a sensation (similar to vibration) on the fingertips of a user while touching the reading area (display) of the refreshable Braille display system 100. The reading area consists of an array of tiny vertically aligned motors 102 with 4 rows and 28 columns (8 dot 14 cells). One of the rows may be rendered completely inactive by actuating a commanding switch thereby making the display as a six-dot display (6 dot 14 cells). If data is available, a microcontroller unit 104 determines the data and actuates the corresponding motors 102 causing them to rotate while the remaining motors 102 continue to be at rest. The visually impaired user may have to move their hand on this display as the normal procedure of reading braille, so they can sense the data effectively and quickly by sensing the status of motors shaft. Visually impaired people who want to learn and use braille, and make use of modern technologies, like smartphone, etc., without limitation are therefore facilitated by the refreshable Braille display system 100. The specially designed keypad helps students to learn braille extremely fast and is easy to type. Moreover, the drastic reduction on price, size, and upgraded features of the refreshable Braille display system 100 provides additional usability to users thereby increasing commercial use. The refreshable Braille display system 100 helps the user in such a way that it focuses on vibration receptors at their fingertips instead of touch receptors which makes the device less expensive, compact, and smaller in size. In contrast, currently available high-cost products use projections in their refreshable braille display actuated by solenoids or piezoelectric actuators.

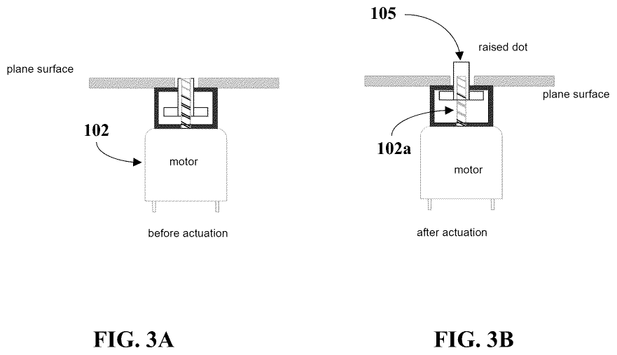

FIG. 3A exemplarily illustrates a Braille dot element 105 in a lowered configuration within an opening. FIG. 3B exemplarily illustrates a Braille dot element 105 in a raised configuration within an opening. As disclosed in the detailed descriptions of FIGS. 1-2, the refreshable Braille display system 100 includes a plurality of Braille cells 101, an interface 103, and a microcontroller unit 104. Each of the braille cells 101 includes an array of openings such that each opening 101a houses a Braille dot element 105 and at least one motor 102 positioned within each opening 101a of the array of openings to raise or lower the Braille dot element 105 as exemplarily illustrated in FIGS. 3A-3B. In an embodiment, the Braille dot element 105 is raised or lowered using a mechanical actuator, for example, a retractable assembly, an expandable assembly, a screw thread arrangement, etc. The microcontroller unit 104 is configured to determine an input received from the interface 103 selectively control the motor 102 of the array of openings 101a based on the determined input. An output shaft 102a of the motor 102 is in contact with an inner surface of the Braille dot element 105. In an embodiment, the input includes information corresponding to the Braille dot elements 105 which must be actuated. In some embodiments, the microcontroller unit 104 selectively controls the at least one motor 102 of the array of openings 101a to cause a rotary motion of the selected Braille dot element 105 based on the determined input. Alternatively, the microcontroller unit 104 selectively controls the at least one motor 102 of the array of openings 101a to cause a vibratory motion of the selected Braille dot element 105 based on the determined input.

The foregoing examples have been provided merely for the purpose of explanation and are in no way to be construed as limiting of the refreshable Braille display system 100, disclosed herein. While the refreshable Braille display system 100 has been described with reference to various embodiments, it is understood that the words, which have been used herein, are words of description and illustration, rather than words of limitation. Further, although the refreshable Braille display system 100 has been described herein with reference to particular means, materials, and embodiments, the refreshable Braille display system 100 is not intended to be limited to the particulars disclosed herein; rather, the refreshable Braille display system 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the refreshable Braille display system 100 disclosed herein in their aspects.

We claim:

1. A refreshable Braille display system (100) comprising a plurality of Braille cells (101), an interface (103), and a microcontroller unit (104), the refreshable Braille display system (100) characterized by:
each of the braille cells (101) comprising:
an array of openings such that each opening (101a) houses a Braille dot element (105);
at least one motor (102) positioned within each opening (101a) of the array of openings, wherein the at least one motor (102) is configured to raise or lower the Braille dot element (105);
the microcontroller unit (104) configured to:
determine an input received from the interface (103); and
selectively control the at least one motor (102) of the array of openings (101a) based on the determined input.

2. The refreshable Braille display system (100) as claimed in claim 1, wherein the Braille dot element (105) is raised or lowered using a mechanical actuator.

3. The refreshable Braille display system (100) as claimed in claim 1, wherein an output shaft (102a) of the at least one motor (102) is in contact with an inner surface of the Braille dot element (105).

4. The refreshable Braille display system (100) as claimed in claim 3, wherein a rotary motion of the output shaft (102a) causes a rotary motion of the Braille dot element (105).

5. The refreshable Braille display system (100) as claimed in claim 3, wherein a vibratory motion of the output shaft (102a) causes a vibratory motion of the Braille dot element (105).

6. A refreshable Braille display system (100) comprising a plurality of Braille cells (101), an interface (103), and a microcontroller unit (104), the refreshable Braille display system (100) characterized by:
each of the braille cells (101) comprising:
an array of openings such that each opening (101a) houses a Braille dot element (105);
at least one motor (102) positioned within each opening (101a) of the array of openings, wherein the at least one motor (102) is configured to raise or lower the Braille dot element (105);
the microcontroller unit (104) configured to:
determine an input received from the interface (103), wherein the input includes information corresponding to the Braille dot elements (105) which must be actuated; and
selectively control the at least one motor (102) of the array of openings (101a) to cause a rotary motion of the selected Braille dot element (105) based on the determined input.

7. The refreshable Braille display system (100) as claimed in claim 6, wherein the Braille dot element (105) is raised or lowered using a mechanical actuator.

8. The refreshable Braille display system (100) as claimed in claim 6, wherein an output shaft (102a) of the at least one motor (102) is in contact with an inner surface of the Braille dot element (105).
